(19) United States
(12) Patent Application Publication
(10) Pub. No.: US 2023/0146992 A1
(43) Pub. Date: May 11, 2023

(54) PORTABLE DEVICE, SYSTEM COMPRISING THE PORTABLE DEVICE, AND METHOD FOR REPORTING AN EMERGENCY

(71) Applicant: WATCHERR NV, Erembodegem (BE)

(72) Inventor: Nikolai STEVENS, Laarne (BE)

(21) Appl. No.: 17/759,966

(22) PCT Filed: Feb. 11, 2021
(86) PCT No.: PCT/IB2021/051111

§ 371 Date: Aug. 2, 2022

(30) Foreign Application Priority Data
Feb. 11, 2020 (BE) BE2020/5081
Nov. 6, 2020 (BE) BE2020/5793

(51) Int. Cl. H04W 4/029; H04W 4/80; H04W 4/021; H04W 4/90; G01S 5/02; G08B 21/04

(52) U.S. Cl. CPC H04W 4/029; H04W 4/80; H04W 4/021; H04W 4/90; G01S 5/0231; G08B 21/0446; G08B 21/0453

(57) ABSTRACT

A wearable emergency notification device configured for wearing around a human wrist is described. The device comprises an accelerometer for fall detection, a heart rate sensor for anomaly detection, an activation button for activation detection, a positioning system for determining position data, and a communication system for data communication. Upon detection of a fall and/or anomaly and/or activation, position data is determined, and an emergency signal comprising the position data is transmitted.

### TECHNICAL FIELD

The invention relates to a wearable device, preferably for wearing on the wrist, comprising an acceleration sensor and a heart rate sensor, wherein the device is configured to detect an emergency situation and wirelessly transmit an emergency signal comprising a position of the device.

### BACKGROUND

WO 2017/079 354 A1 describes a wearable device for transmitting an emergency signal. The device may be configured to be worn by a human on a wrist. The device may include a processor, a memory, a display (e.g., a passive matrix organic light emitting diode (PMOLED)), a microphone, a speaker, a network element (an antenna and associated components, Wi-Fi, Bluetooth), push buttons for activating and deactivating an emergency signal, a physiological sensor such as a heart rate sensor, an accelerometer (for fall detection), a Global Positioning System (GPS) sensor, and a slot for a Subscriber Identity Module (SIM) card. The distress signal may include location data based on GPS, cellular triangulation, a Wi-Fi positioning system (WPS), an indoor positioning system (IPS), or any other form of location data. The document describes a sensor for measuring a health parameter, such as a photo detector operating in the visible and infrared spectrum of light to measure reflection of emitted light. The portable device can send out an emergency signal without user intervention, when data from at least one sensor indicates an emergency situation, or with user intervention, by pressing the corresponding push button. In one embodiment, sensor data indicates an emergency situation when a running average falls outside a predetermined emergency limit, preferably for a minimum period of time. The document describes repeatedly sending a distress signal through one or more channels and to one or more devices, according to a predefined heuristic, until a distress signal reaches a destination or a predefined number of failed attempts. Upon response to the distress signal, the portable device may receive a Session Initiation Protocol (SIP) signal. An associated supporting computer program product may include a web application and/or a mobile application.

However, the document does not provide for energy saving measures.

US 2019/124469 describes a wireless location recognition for wearable device.

The present invention aims to solve at least some of the above-mentioned problems.

### SUMMARY OF THE INVENTION

In a first aspect, the invention concerns a portable device for reporting an emergency situation, according to claim 1.

In a second aspect, the invention relates to a system for reporting an emergency situation, comprising a portable device according to the first aspect and a medicine cabinet, according to claim 32.

In a third aspect, the invention relates to an emergency notification system comprising a portable device according to the first aspect, a server, and a computer program product comprising firmware for the portable device and a mobile application and/or web application, according to claim 33.

In a fourth aspect, the invention relates to a system for monitoring activities, comprising a portable device according to the first aspect, a server, and a computer program product comprising firmware for the portable device and a mobile application and/or web application, according to claim 35.

In a fifth aspect, the invention relates to a method for reporting an emergency situation, according to claim 37.

Someone with ordinary knowledge in the field will appreciate that the portable device is preferably configured to perform the method, and that consequently the method can be performed using the portable device. Any feature described in this document, above and below, may therefore relate to any of the five aspects of the present invention.

The invention is advantageous because the initial (attempted) determination of position data via Bluetooth requires significantly less energy than determination of position data via GNSS. The latter is only performed if the initial determination via Bluetooth is not possible. Due to the interaction between the two technologies, less energy is required and the device can operate autonomously on battery for a longer period.

Further advantages are described in the detailed description.

### DESCRIPTION OF THE FIGURES

FIG. 1 shows a schematic representation of an algorithm of an embodiment according to the present invention.

FIG. 2 shows a schematic representation of hardware components of an embodiment of a portable device according to the present invention.

FIG. 3 shows a perspective view of an embodiment of a portable device according to the present invention.

FIG. 4 shows a perspective view of an embodiment of an external battery according to the present invention.

### DETAILED DESCRIPTION

The invention relates to a portable device, a system and a method for reporting an emergency situation. The invention has been summarised in the section provided for that purpose. In what follows, the invention is described in detail, preferred embodiments of the invention are explained, and the invention is illustrated by means of examples.

Unless otherwise defined, all terms used in the description of the invention, including technical and scientific terms, have the meaning generally understood by those skilled in the technical field of the invention. For a better assessment of the description of the invention, the following terms are explained explicitly.

In this document, “a”, “the” and “it” refer to both the singular and the plural unless the context clearly indicates otherwise. For example, “a segment” means one or more than one segment.

When “approximately” or “round” is used in this document with respect to a measurable quantity, a parameter, a time or moment, and the like, variations are meant of +/−20% or less, preferably +/−10% or less, more preferably +/−5% or less, even more preferably +/−1% or less, and even more preferably +/−0.1% or less than and of the quoted value, insofar as such variations are applicable in the described invention. However, it should be understood that the value of the quantity where the term “about” or “around” is used is itself specifically disclosed.

The terms “comprise”, “comprising”, “consist of”, “consisting of”, “providing for”, “contain”, “containing”, “include”, “including” are synonyms and are inclusive or open terms indicating the presence of what follows, which do not exclude or prevent the presence of other components, characteristics, elements, members, steps, known from or described in the state of the art.

The quoting of numerical intervals through the endpoints includes all integers, fractions and/or real numbers between the endpoints, these endpoints included.

In a first aspect, the invention relates to a portable device for reporting an emergency situation. Preferably, the device is configured for wearing around a human wrist. Preferably, the device is configured for attachment around a human wrist. Preferably the device is a wristwatch. Preferably the device is a smartwatch.

In a preferred embodiment, the device comprises an accelerometer. Preferably, the device is configured to detect a fall based on signals from the accelerometer. Preferably, the device is configured to determine a number of steps per predetermined unit of time based on signals from the accelerometer. Preferably, a distress signal is automatically sent when the user remains on the ground for more than 30 seconds.

Preferably, the device is configured to determine wrist and arm movements based on signals from the accelerometer.

An example of an accelerometer and corresponding configuration for fall detection is described in Ning Jia, “Detecting Human Falls with a 3-Axis Digital Accelerometer”, Analog Dialogue Vol. 43, No. 3, Art. 7, July (2009).

In a preferred embodiment, the device is configured to detect by means of a heart rate sensor an increased heart rate during and/or after detection of a fall. Preferably, the heart rate sensor is a photoplethysmography (PPG) sensor. A fall is accompanied by an increased heart rate, for example due to a startle reaction or the release of adrenaline. By combining the detection of a fall, as described in an earlier embodiment, with the detection of an increased heart rate, the number of false positive detections of a fall is reduced.

Preferably, the PPG sensor uses green light. The PPG sensor is at least accurate up to an upper limit of 240 heart beats per minute (bpm).

In a preferred embodiment, the device comprises an anomaly sensor. Preferably, the anomaly sensor is a heart rate sensor. Preferably, the device is configured to detect an anomaly based on signals from the anomaly sensor. A non-exhaustive example list of anomalies comprises a cardiac arrest; a drowning; a suffocation; and an electrocution. Preferably, the device is configured to detect skin contact based on signals from the anomaly sensor. Preferably, the device is configured to determine a heart rate based on signals from the heart rate sensor. Preferably, the device is configured to detect an anomaly based on signals from the anomaly sensor. Preferably, the device is configured to detect a cardiac arrest based on signals from the anomaly sensor. Preferably, the device is configured to detect a drowning based on signals from the anomaly sensor. Preferably, the device is configured to detect a suffocation based on signals from the anomaly sensor. Preferably, the device is configured to detect an electrocution based on signals from the anomaly sensor. Preferably, the device is configured to detect an anomaly based on heart rate, preferably when the determined heart rate falls outside a predetermined heart rate limit (e.g., lower than 30 heartbeats per minute) for a predetermined time period (e.g., 20 seconds) while skin contact is detected. Preferably, the anomaly sensor is a photoplethysmography (PPG) sensor.

In a preferred embodiment, the device is configured to detect by means of a heart rate sensor a decreased heart rate during sleep. In a more preferred embodiment, the heart rate sensor is a photoplethysmography (PPG) sensor. During sleep, the body is at rest and the heart rate lowers. A non-decreased heart rate is an indication that the body is not at rest and may indicate underlying physical and/or mental problems, such as but not limited to sleep problems or breathing problems. Preferably, the device comprises an accelerometer. An accelerometer is suitable for determining a long-term horizontal position of a user, indicating a sleeping position.

During cardiac arrest, chances of survival decrease by 10% for each passing minute. The portable device allows immediate detection of a cardiac arrest, and in particular the sending of an emergency signal, see below. Rapid medical intervention significantly increases the chances of survival.

In a preferred embodiment, the device is configured to detect water between the PPG sensor and a user's skin. This is advantageous because water can interfere with measurements from the PPG sensor. This can lead to erroneous heart rate measurements, incorrectly detecting an anomaly. When water is detected between the PPG sensor and a user's skin, the device will not send an anomaly signal based on measurements from the PPG sensor.

In a preferred embodiment, the device comprises a positioning system. Preferably, the device is configured to detect an exit outside a predetermined area (geofencing) based on signals from the positioning system. Preferably, the device comprises a Global Navigation Satellite System (GNSS) sensor. Preferably the GNSS sensor is a Global Positioning System (GPS) sensor, more preferably an assisted GPS (A-GPS) sensor, but the GNSS sensor may alternatively be e.g. a GLONASS or Galileo sensor. Preferably the device comprises a Bluetooth module. Preferably the Bluetooth module is a Bluetooth Low-Energy (BLE) module, more preferably according to standard BLE 4.2. The Bluetooth module may comprise an nRF52840 chip antenna. Preferably, the positioning system is configured to attempt to determine position data via the Bluetooth module, and when position data cannot be determined based on the Bluetooth module, to determine position data based on the GNSS sensor. Preferably, the device is configured to obtain position data based on the Bluetooth module and two, three, four or more Bluetooth beacons (e.g. ‘Bluetooth mesh’), external to the portable device, by determining relative signal strengths and/or transmission time differences, more preferably based on multilateration, such as triangulation, based on predetermined positions of the Bluetooth beacons and transmission time differences.

In an embodiment, the device is configured to send signals received from said Bluetooth beacons to a server via a wireless network and one or more gateways. The server is configured to obtain position information from the device based on the signals received by the device, by determining relative signal strengths and/or transmission time differences, more preferably based on multilateration, such as triangulation, based on predetermined positions of the Bluetooth beacons and transmission time differences. The one or more gateways are powered using Power over Ethernet (PoE).

In a preferred embodiment, the device comprises an activation button (a distress button). Preferably, the device is configured to detect an activation based on signals from the activation button. Preferably, the activation button comprises a top layer and a pressure sensor, wherein the top layer and the pressure sensor comprise a spacing in the resting state. This prevents unintended activation via the activation head.

In a preferred embodiment, the device comprises a communication system. Preferably, the device comprises a Bluetooth module. Preferably, the Bluetooth module is a Bluetooth Low-Energy (BLE) module, more preferably according to standard BLE 4.2. The Bluetooth module may comprise an nRF52840 chip antenna. Preferably, the Bluetooth module can connect the device to a local SIP server or GSM repeater via a Bluetooth network external to the device to achieve external communication. Preferably, the device comprises a mobile network module. The mobile network module is, for example, a 2G module. Preferably, the mobile network module is a 4G or 5G module, more preferably a 4G LTE module. Preferably the device comprises a receiving module for a Subscriber Identity Module (SIM) card, more preferably a nano-SIM card, even more preferably an embedded-SIM (eSIM). Preferably the device comprises a Wi-Fi module. Preferably the communication system is configured to attempt data communication via the Bluetooth module, and when data communication via the Bluetooth module is not possible, data communication via the mobile network module and/or Wi-Fi module. Preferably, the device is configured to request or transmit data via the mobile network module only via mobile Internet.

This is advantageous because the initial (attempted) data communication via Bluetooth requires considerably less energy than data communication via the mobile network module and/or Wi-Fi module. Data communication via the latter(s) is only performed when data communication via Bluetooth is not possible. Due to the interaction between both technologies, less energy is needed and the device can operate autonomously on battery for a longer time.

In a preferred embodiment, the device is configured to determine position data based on the positioning system upon detection of an activation and/or optionally a fall and/or optionally an anomaly and/or optionally an egress, preferably upon detection of at least one of a fall, an anomaly, an exit and an activation, and to transmit a distress signal via the communication system. Preferably, the distress signal comprises the position data. Preferably the distress signal is an electromagnetic distress signal. Preferably, the emergency signal will comprise the name of the user. Preferably, the emergency signal will comprise the user's address. Preferably, the emergency signal will comprise the date and time when the emergency signal was triggered. Preferably, the distress signal comprises the cause of the distress signal (fall; anomaly; exit; activation). The distress signal may comprise sensor data.

Alternatively or additionally, the device may be configured to periodically determine position data based on the positioning system according to a predetermined time interval and to transmit a position signal via the communication system, where the position signal comprises the position data.

In a preferred embodiment, the device comprises a cancel button. Preferably, the device is configured to stop sending an emergency signal based on signals from the cancel button.

In a preferred embodiment, the device comprises a loudspeaker. Preferably, the device comprises a microphone. Preferably, the device is configured for bidirectional audio communication via the communication system, the microphone and the speaker. Preferably the bidirectional audio communication is bidirectional VoIP audio communication, more preferably bidirectional VoIP audio communication according to the MQ Telemetry Transport (MQTT) network protocol. Preferably the device is configured to answer incoming calls via a SIM card via bidirectional audio communication via the microphone and the speaker, preferably only incoming calls, i.e. no outgoing calls.

In a preferred embodiment, the device is configured to also emit sound waves during the emission of an emergency signal. Preferably, these sound waves relate to a periodic beep tone. Preferably, these sound waves are generated in a hardware component of the device other than said speaker, preferably in a modem module, Wi-Fi module, mobile network module or MCU. These sound waves are advantageous because they can inform the wearer of the portable device and consequently warn or reassure, as the case may be, that an emergency signal is being sent.

In a preferred embodiment, the device comprises a screen, preferably a light emitting diode (LED) screen, more preferably an organic LED (OLED) screen, even more preferably a passive matrix OLED (PMOLED) screen. Preferably the screen has a diameter of about 1.3 inches. Preferably the screen has about 128 by about 40 pixels.

In a preferred embodiment, the device comprises a processor, a tangible transitive computer-readable memory, and a tangible non-transitory computer-readable memory. Preferably, the device is configured to store data based on signals from one or more of the sensors and/or systems on the tangible non-transitory computer-readable memory. Preferably, the processor is a Cortex M4F. Preferably, the processor has a clock speed of about 48 MHz. Preferably, the tangible non-transitory computer-readable memory is a flash drive, preferably of about 1 MB. Preferably, the tangible transitory computer-readable memory is a Random Access Memory of 256 KB. Preferably, the device comprises a Micro Controller Unit (MCU) comprising said processor, and said transitory and non-transitory memories.

In a preferred embodiment, the device is configured to display a time on the screen, such as a current time based on a signal received from the GNSS sensor and/or antenna of the GNSS sensor.

In a preferred version, the device is dust- and water-proof in accordance with the International Protection Rating (IP67). The unit is protected against contact with harmful dust. It is also protected against immersion in water to a depth of 1 meter for up to 30 minutes.

In a preferred embodiment, the device comprises a battery. Preferably, the battery is a Li-ion battery, such as a Li-ion battery of at least 200 mAh, preferably at least 300 mAh, more preferably at least 450 mAh, such as a battery of about 520 mAh. Preferably the device comprises a charging port, such as a micro-USB port or a pogo pin charging port. Preferably the charging port is a magnetic pogo 4-pin charging port.

In a preferred embodiment, the device comprises a cradle. The holder comprises a charging cable and a charging connector. The charging cable is preferably a USB cable, the first end of which is connectable to a USB port of a computer, a USB charger, a power bank or other suitable charging device. The second end of the charging cable is firmly attached to the holder. Preferably, the second end of the charging cable is detachably attached to the cradle. The charging connector is configured to be in contact with the device's charging port when the device is placed in the holder.

In a preferred version, the device comprises an external battery. The external battery is detachably attached to the device. Preferably, the external battery is snapped onto the device in a waterproof manner. The device and the attached external battery meet the requirements of IP 66, preferably IP 67. The external battery is electrically connected to the device by means of electrical contacts. The electrical contacts are preferably pogo pins. The device is configured to charge its battery by means of the external battery. The external battery is preferably a Li-ion battery, such as a Li-ion battery of at least 200 mAh, preferably at least 300 mAh, more preferably at least 450 mAh, such as a battery of about 520 mAh. The external battery is suitable for charging in a separate charger. The separate charger is configured to charge at least 1, preferably at least 3, more preferably at least 5 and even more preferably at least 10 external batteries. The separate charger comprises a connection cable for connecting the separate charger to the mains.

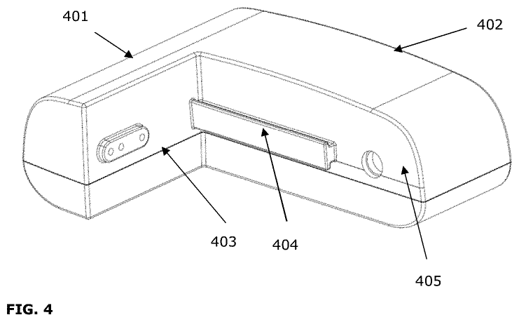

FIG. 4 shows a perspective view of an implementation form of an external battery according to the present invention. The external battery 401 comprises a housing 402 with Li-ion battery. The housing 402 further comprises electrical contacts 403 for connecting the battery to the device. To attach the external battery 401 to the device, the housing comprises an elongated protrusion 404 and an opening 405. The external battery 401 is slid onto the device, with the elongated protrusion 404 sliding into a corresponding slot in the device. The external battery 401 is detachably attached to the device by means of a spring-loaded pin or ball, comprised in the device, which snaps into the opening 405.

In a preferred version, the device comprises a Near-Field Communication (NFC) chip. In a preferred embodiment, the device comprises a digital key of an asymmetric key pair. Preferably, the device is configured to encrypt data, such as e.g. position data, name, sensor data and the like, based on the key. Preferably, the distress signal comprises encrypted data, such as encrypted position data.

In a preferred embodiment, the device comprises a body. Preferably, the body has dimensions of about 45.9 mm by about 45.9 mm by about 13.95 mm. Preferably, two cooperating bands are attached to the body, such as two cooperating bands based on Velcro or two cooperating bands based on a buckle and through holes for the buckle. In an alternative embodiment, an elastic strap may be attached to the body at two ends, so as to enclose a human wrist. Preferably, the body comprises an upper side and a lower side. Preferably, the body comprises a sidewall, which spans the top and bottom. Preferably the top side comprises the screen. Preferably the top side comprises the activation button. Preferably the top side encloses the microphone. Preferably the top side comprises the speaker. Preferably, the activation button is positioned between the microphone and the loudspeaker. Preferably, the side encompasses the deactivation button. Preferably the side comprises the charging port. Preferably the bottom side comprises the anomaly sensor. Preferably the body also comprises the other hardware components described above. Preferably, the body comprises a weight of about 40 grams.

FIG. 3 shows a perspective view of an implementation form of a portable device according to the present invention. The body comprises at the top a speaker 301, a microphone 302, a screen 303 (preferably a 1.3″ PMOLED with 128×40 pixels), and an activation button 306. The body comprises on its bottom side an anomaly sensor 307 (preferably a PPG sensor). The body comprises on the side wall a deactivation button 305, and a charging port 304 (preferably magnetic 4-pin pogo charging port). Other hardware components are located in the body, as specified herein according to preferred embodiments.

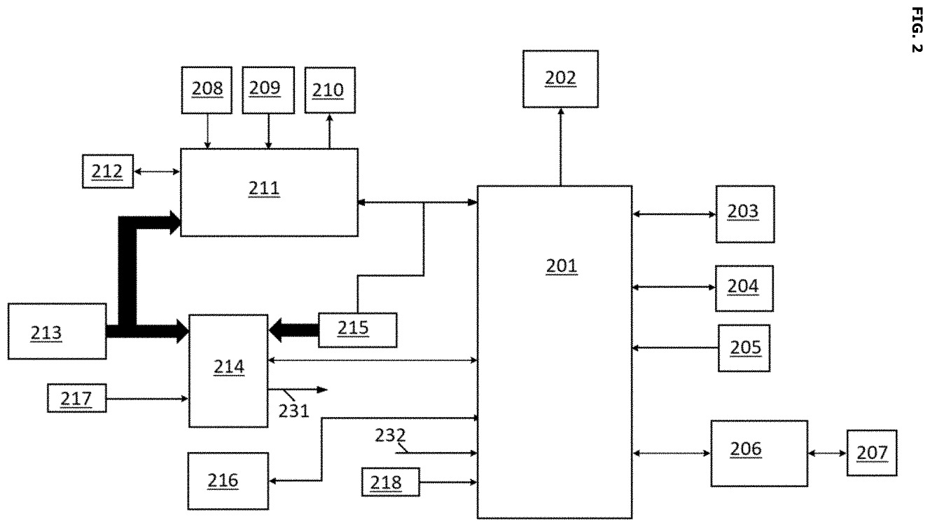

FIG. 2 shows a schematic representation of hardware components of an embodiment of a portable device according to the present invention. The portable device comprises an MCU 201 (preferably a Cortex M4F at 48 MHz, 1 MB flash and 256 KB RAM), a screen 202 (preferably a 1.3″ PMOLED with 128×40 pixels), an accelerometer 203 (G-sensor), a Serial Wire Debug (SWD) interface 204, an anomaly sensor 205 (preferably a PPG sensor), a GNSS sensor (preferably A-GPS sensor) comprising a GNSS module 206 and a GNSS antenna 207, a cellular network module 211 (preferably a 4G LTE module) an antenna 208, a microphone 209, a speaker 210, an insertion module 212 for a SIM card (preferably nano-SIM), a battery 213 (preferably 520 mAh Li-ion), a charger 214, a charging port 215 (preferably magnetic 4-pin pogo charging port), an activation button 217, a BLE module 216 (preferably BLE 4.2 nrf52840 chip antenna), and a deactivation button 218. The charger may comprise a further output 231. Preferably, the device is also configured to be turned on via the activation button, but alternatively, the device may be configured to be turned on via an input 232 of the MCU.

Preferably, the 212 insertion module is not an insertion module but an integrated module with SIM functionality, an eSIM.

In a preferred embodiment, the device is configured to display icons on the screen. Examples of icons comprise icons related to battery consumption, connectivity, emergency signalling, heart rate, fall detection monitoring, bi-directional audio communication, GNSS, geofencing, sound wave generation during emergency signalling, and the like.

In a preferred embodiment, the device meets the requirements of a class I medical device. This allows the device, comprising the software, to be used for diagnosis, prevention, monitoring, treatment or alleviation of disease or for diagnosis, monitoring, treatment, alleviation or compensation of injury or disability, where there is minimal risk.

In a preferred embodiment, the external battery meets the requirements of a Class I medical device.

In a further preferred embodiment, the device meets the requirements of a Class IIb medical device. This allows the device, comprising the software, to be used for diagnosis, prevention, monitoring, treatment or alleviation of disease or for diagnosis, monitoring, treatment, alleviation or compensation of injury or disability, where there is a high potential risk. In particular, the device may therefore be used for the direct diagnosis or monitoring of vital physiological functions, where the nature of variations in the vital physiological parameters can lead to immediate danger for a patient. Non-exhaustive examples are variations in cardiac, respiratory and central nervous system performance.

In a preferred embodiment, the Bluetooth beacons and gateways meet the requirements of a Class IIb medical device.

In a second aspect, the present invention relates to a system for reporting an emergency situation. The system comprises a portable device according to the first aspect and a medicine box. The medicine box comprises an opening detector. The system is configured for verifying that the opening detector has detected an opening within a predetermined time period, and if not, generating an audible and/or visual warning signal via the portable device.

According to an embodiment, the medicine box comprises a proximity sensor and an electronic lock. The proximity sensor is configured to detect the portable device in proximity to the medicine box. Proximity is less than 20 cm, preferably less than 15 cm, more preferably less than 10 cm, even more preferably less than 5 cm, and even more preferably less than 2 cm. The proximity sensor is configured to generate a signal, suitable for activating the electronic lock, upon detection of the portable device in the vicinity. Activation in this context means that the electronic lock is opened for a period of time, after which it closes again automatically.

It is clear to a person skilled in the technical field that the proximity sensor signal can also be used for closing an electronic lock or for opening and closing an electronic lock or for activating other devices or equipment, such as lights. It is also clear to a specialist in the technical field that the electronic lock can also be used for access control, for example for opening and closing doors.

In a third aspect, the present invention relates to a system for reporting an emergency situation. The system comprises a portable device according to the first aspect, a server, and a computer program product. Preferably, the server comprises a second digital key of said asymmetric key pair. Preferably, the computer program product comprises firmware for the portable device. Preferably the computer program product comprises a mobile application and/or a web application. Preferably, the computer program product is configured to enter and store contact information, such as for example a phone number, of one or more contacts on the server via the mobile application and/or web application. Preferably, the firmware is configured to send the emergency signal from the portable device to the server. Preferably, the server is configured to send an emergency notification based on an incoming emergency signal and based on the contact information, e.g., according to a predetermined sequence and/or number of attempts. Preferably, the server sends an emergency notification according to the predetermined contact information one-by-one in a loop. For example, when a contact with contact information 1 does not answer for a predetermined time period (e.g. 30 seconds), the server switches to a notification based on contact information 2, etc. Preferably, the server repeats sending a notification according to the plurality of contact data when in a first loop nobody answers. A person can cancel, accept, or externally escalate a notification of need by pressing a corresponding icon in a GUI of the application. Preferably the maximum number of loop repeats is 3. Preferably, an emergency notification is displayed on a contact's smartphone. Preferably, upon acceptance of the notification of emergency, a bidirectional audio communication is initiated via the SIM of the contact to a SIM in the portable device. Preferably, in case the portable device is configured for use in a SIP environment, bidirectional audio communication is initiated via a SIP number of the portable device, rather than via the SIM number. Preferably, the system is configured to distribute a notification via the server to one or more contacts when the battery level is below a predetermined limit, whereby the latter can observe this via the application. The application is further configured to manage and consult all administrative data, such as contact list, historical sensor data, historical distress signals, etc.

The portable device can be distributed to care homes such as retirement homes, service flats, nursing homes and hospitals. The portable device can be worn indoors, e.g. in a care home, as well as outdoors, e.g. in the open air. The wearable device allows detection of unexpected life-threatening conditions (anomalies), such as cardiac arrest, drowning, suffocation and electrocution. The portable device is designed to facilitate, streamline and expedite medical assistance.

During a consultation of a dependent person with a care provider, the care provider can configure the portable device for the dependent person by setting personal parameters, i.e. which are specific to the dependent person. Such parameters can be set via a password-protected mobile application and/or web application, such as a web site. Via this mobile application and/or web application, a care provider can also analyse data obtained via the portable device with a view to pattern recognition. A non-exhaustive example list of personal parameters comprises:
a lower limit for heart rate, preferably in heart beats per minute (bpm), e.g. 30 bpm;
a schedule for taking medication;
an area outside which the person in need of assistance is not expected to move (indoors and/or outdoors);
an activation of fall detection.

In a fourth aspect, the present invention relates to a system for monitoring daily activities. The system comprises a portable device according to the first aspect, a server, and a computer program product. Preferably, the server comprises a second digital key of said asymmetric key pair. Preferably, the computer program product comprises firmware for the portable device. Preferably the computer program product comprises a mobile application and/or a web application. Preferably, the computer program product is configured to enter and store contact information, such as for example a phone number, of one or more contacts on the server via the mobile application and/or web application. Preferably, the firmware is configured to transmit wrist and arm movements and/or position data and/or data from an accelerometer from the wearable device to the server. Preferably, the server is configured to monitor trends in daily activities based on the received wrist and arm movements and/or the position data and/or the data from the accelerometer and to send a notification in case of deviations in the pattern of daily activities based on the contact data. Preferably, the server for this purpose comprises an advanced algorithm suitable for data analysis and machine learning, wherein the machine learning learns a normal pattern of daily activities of a user in a first phase and detects deviations from the normal pattern in a second phase.

A non-exhaustive list of daily activities suitable for monitoring comprises cooking, sleeping comprising sleep pattern, showering, eating, drinking, washing, brushing teeth, walking, visiting the toilet, social activity and physical activity. Daily activities can be recognised based on wrist and arm movements and/or position data. Alternatively, no wrist and arm movements, but data from an accelerometer are processed on the server. Deviations in daily activities can alert caregivers to health risks at an early stage. It is preferable for both people in need of care and caregivers to wear a wearable device, because deviations in interactions between people in need of care and caregivers can also indicate health risks. A non-exhaustive list of possible health risks that can be detected early in this way comprises heart problems, fall risks, depression, dementia, malnutrition, dehydration and heart, urinary and gastroenterological problems.

The application is further configured to manage and consult all administrative data, such as contact list, historical sensor data, historical notifications, etc.

In an embodiment, the server is configured to manage notifications, wherein a notification comprises a timestamp and wherein the server is configured to send after the expiration of a predetermined time span since the timestamp of the notification to a subsequent contact if the notification was not handled by a previous contact. The time span is, for example, one day, two days, three days, four days, five days, six days, one week, or any other suitable time span.

In a preferred embodiment, the server is configured to determine contacts between users based on position data and associated timestamps. This is advantageous so that in the absence of contacts, a social isolation of a user can be detected. It is also advantageous in the case of outbreaks of infectious diseases, such as but not limited to Covid-19, to determine with whom a sick person has had contact.

In a fifth aspect, the present invention relates to a method for notifying an emergency situation. The method comprises the steps of:
Monitoring of a needy person for:
   a fall via an accelerometer;
   an anomaly via an anomaly sensor, preferably heart rate sensor, more preferably PPG sensor;
   preferably, an exit outside a predefined area via a positioning system; and
   an activation via an activation button;
detecting a fall and/or anomaly and/or optional exit and/or activation;
determination of position data, trying to determine the position data on the basis of Bluetooth triangulation, and, if the position data cannot be determined on the basis of Bluetooth triangulation, determining the position data on the basis of GNSS;
Sending out a distress signal comprising position data.

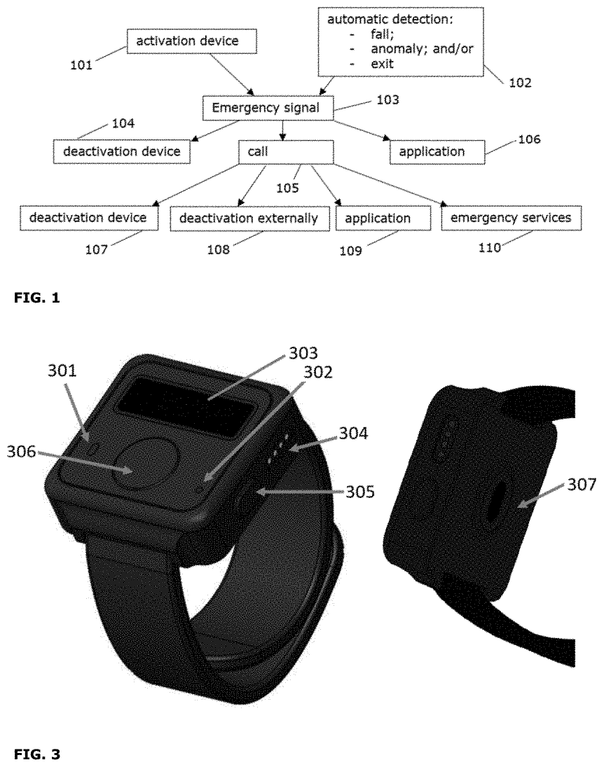

FIG. 1 shows a schematic representation of an algorithm of an execution form according to the present invention. A distress signal 103 may originate in various situations:
manually, via user activation button 101; and/or
automatically, via detection of a fall based on signals from the accelerometer, detection of an anomaly based on signals from the anomaly sensor, and/or detection of an exit from a predefined area via a positioning system 102.

The emergency signal can result in bidirectional audio communication 105, e.g. with a caregiver or family member. The emergency signal can be deactivated externally 108, e.g. via the application 109, or the emergency services 110 can be notified (external escalation). Alternatively or additionally, the emergency signal can be registered on the server and later viewed via the application 106. Alternatively or additionally, the emergency signal can invoke further assistance, such as contacting emergency services, via the application 106. At any time, the user can manually deactivate the emergency signal by pressing the deactivation button 104, 107.

Someone with ordinary knowledge in the field will appreciate that the portable device is preferably configured to perform the method, and that consequently the method can be performed using the portable device. Any feature described in this document, above and below, may therefore relate to any of the five aspects of the present invention.

The portable device can be carried by a person in need of care, such as an elderly person, a demented person, a child, etc.

The device may also comprise other features, such as:
one or more other physiological sensors in addition to the anomaly sensor and accelerometer, such as the physiological sensors described in WO 2017/079 354 A1;
one or more environmental sensors, such as the environmental sensors described in WO 2017/079 354 A1 (temperature, smoke, radiation, etc.);
one or more other communication aids, such as the communication aids described in WO 2017/079 354 A1 (camera, etc.).

1. Portable emergency notification device configured to be attached to a human wrist, wherein the device comprises an accelerometer, a heart rate sensor, an activation button, a positioning system, and a communication system, wherein the device is configured to:
detect a fall based on signals from the accelerometer;
detect an anomaly based on signals from the heart rate sensor;
detect an activation based on signals from the activation button;
determine position on the basis of signals from the positioning system when a fall and/or anomaly is detected and/or triggered, and transmit a distress signal containing the position information via the communication system,
wherein the device comprises a GNSS sensor and a Bluetooth module, with the feature that the positioning system is configured to attempt to determine the position data based on the Bluetooth module, and if the position data cannot be determined based on the Bluetooth module, to determine the position data based on the GNSS sensor.

2. The portable device of claim 1, wherein the device comprises a mobile network module and/or Wi-Fi module, wherein the communication system is configured to attempt data communication via the Bluetooth module, and wherein data communication via the Bluetooth module is not possible, to attempt data communication via the mobile network module and/or Wi-Fi module.

3. The portable device of claim 1, wherein the device is configured to detect an exit outside a predetermined area based on signals from the positioning system.

4. The portable device according to claim 3, wherein the device is configured to determine position data based on signals from the positioning system upon detection of a fall and/or anomaly and/or activation and to transmit an emergency signal comprising the position data via the communication system.

5. The portable device of claim 1, wherein the device comprises a microphone and a loudspeaker, wherein the device is configured for bidirectional audio communication via the communication system, the microphone and the loudspeaker.

6. The portable device according to claim 5, wherein the bidirectional audio communication is bidirectional VoIP audio communication.

7. The portable device according to claim 6, wherein the bidirectional audio communication is bidirectional VoIP audio communication according to the MATT network protocol.

8. The portable device of claim 1, wherein the device is configured to also emit sound waves during the emission of an emergency signal.

9. The portable device of claim 1, wherein the heart rate sensor is a photoplethysmography (PPG) sensor, wherein the device is configured to detect skin contact based on signals from the PPG sensor, and wherein the device is configured to determine a heart rate based on signals from the PPG sensor.

10. The portable device according to claim 1, wherein the Bluetooth module is a Bluetooth Low Energy (BLE) module.

11. The portable device of claim 1, wherein the GNSS sensor is a GPS sensor, preferably an A-GPS sensor.

12. The portable device of claim 1, wherein the mobile network module is a 2G module, preferably a 4G or 5G module, more preferably a 4G LTE module.

13. The portable device of claim 1, wherein the device comprises a receiving module for a SIM card, preferably a nano-SIM card, more preferably an eSIM.

14. The portable device of claim 1, wherein the device comprises a screen, preferably a light emitting diode (LED) screen, more preferably an organic LED (OLED) screen, still more preferably a passive matrix OLED (PMOLED) screen.

15. The portable device according to claim 14, wherein the device is configured to display a time on the screen.

16. The portable device according to claim 1, in which the device is dustproof and waterproof according to specification IP67.

17. The portable device according to claim 1, wherein the device comprises a battery, more preferably a 520 mAh Li-ion battery.

18. The portable device according to claim 1, wherein the device comprises a charging port, more preferably a pogo pin charging port, more preferably a magnetic pogo 4 pin charging port.

19. The portable device according to claim 18, wherein the device comprises a holder, comprising a charging connector and a charging cable, wherein the charging connector is configured to be in contact with the charging port of the device when the device is placed in the holder.

20. The portable device according to claim 17, wherein the device comprises an external battery, wherein the external battery is detachably attached to the portable device, and wherein the external battery is configured to charge the battery of the external device.

21. The portable device according to claim 1, wherein the device is configured to determine a number of steps per predetermined unit of time based on signals from the accelerometer.

22. The portable device according to claim 1, wherein the device is configured to obtain position information based on the Bluetooth module and two, three, four or more Bluetooth beacons by determining relative signal strengths and/or transmitting time differences, preferably based on multilateration, preferably triangulation, based on predetermined positions of the Bluetooth beacons and transmitting time differences.

23. The portable device according to claim 1, wherein the device comprises a processor, a tangible computer-readable transitory memory, and a tangible computer-readable non-transitory memory.

24. The portable device according to claim 23, wherein the device is configured to store data based on signals from one or more of the sensors and/or systems on the tangible non-transitory computer readable memory.

25. The portable device according to claim 1, wherein the device comprises a digital key of an asymmetric key pair, wherein the device is configured to encrypt data, such as position data, based on the key, wherein the distress signal comprises encrypted data.

26. The portable device according to claim 1, wherein the device comprises an NFC chip.

27. The portable device according to claim 1, wherein the device comprises a deactivation button, wherein the device is configured to stop sending an emergency signal based on signals from the deactivation button.

28. The portable device according to claim 1, wherein the device is configured to detect, by means of a heart rate sensor, an increased heart rate during and/or after detection of a fall.

29. The portable device according to claim 1, wherein the device is configured to detect by means of a heart rate sensor a reduced heart rate during sleep.

30. The portable device according to claim 1, whereby the device fulfils the requirements of a class I medical device.

31. The portable device according to claim 1, whereby the device fulfils the requirements of a class IIb medical device.

32. Emergency notification system, wherein the system comprises a handheld device according to any one of the preceding claims and a medicine box, wherein the medicine box comprises an opening detector, wherein the system is configured to verify that the opening detector has detected an opening within a predetermined time period, and if not, to generate an audible and/or visual warning signal through the handheld device.

33. The emergency notification system, wherein the system comprises a portable device according to claim 1, a server, and a computer program product, wherein the computer program product comprises firmware for the portable device, wherein the computer program product comprises a mobile application and/or a web application, wherein the computer program product is configured to enter contact information, such as e.g. a phone number, of one or more contacts and storing it on the server, wherein the firmware is configured to send the distress signal to the server, wherein the server is configured to send the distress signal according to the contact information.

34. The emergency notification system, wherein the system comprises a portable device according to claim 1, and two, three, four or more external Bluetooth beacons.

35. System for monitoring daily activities, wherein the system comprises a wearable device according to claim 1, a server and a computer program product, wherein the computer program product comprises firmware for the wearable device, wherein the computer program product comprises a mobile application and/or a web application, wherein the computer program product is configured to enter and store contact information of one or more contacts on the server via the mobile application and/or web application, wherein the firmware is configured to transmit wrist and arm movements and/or position data and/or accelerometer data from the wearable device to the server, wherein the server is configured to monitor trends in daily activities based on the received wrist and arm movements and/or position data and/or accelerometer data and to send a notification in the event of deviations in the pattern of daily activities

36. The system for monitoring daily activities according to claim 35, wherein the server is configured to determine contacts between users based on position data and associated timestamps.

37. Method for notifying an emergency, comprising the steps of:
Monitoring of a needy person for:
a fall via an accelerometer;
an anomaly via a heart rate sensor;
optional exit outside a predefined area via a positioning system; and
an activation via an activation button;
detecting a fall and/or anomaly and/or optional exit and/or activation;
determination of position data, trying to determine the position data on the basis of Bluetooth triangulation, and, if the position data cannot be determined on the basis of Bluetooth triangulation, determining the position data on the basis of GNSS;
Sending out a distress signal comprising position data.
